(19) United States
(12) Patent Application Publication
(10) Pub. No.: US 2010/0250445 A1
(43) Pub. Date: Sep. 30, 2010

(54) Commitment tracking system

(76) Inventor: Robert J. Solheim, Scottsdale, AZ (US)

Correspondence Address: GALLAGHER & KENNEDY, P. A., 2575 E. CAMELBACK RD. #1100, PHOENIX, AZ, 85016, US

(21) Appl. No.: 12/383,768

(22) Filed: Mar. 25, 2009

(51) Int. Cl. G06Q 10/00; G06Q 30/00; G06F 3/048

(52) U.S. Cl. 705/80; 705/7; 715/783

(57) ABSTRACT

There is provided a commitment tracking system that allows for interactive input and output from multiple users including vendors and customers. The commitment tracking system allows the parties to a project to view with transparency the development of the project, its negotiation, finalization, and implementation. The commitment tracking system allows a party to identify individual commitments from multiple commitment sources. Another party can likewise populate a work breakdown structure that includes projects, deliverables, and artifacts. The parties can link individual artifacts with commitments so as to define the agreement and monitor progress and/or changes to the agreement.

### FIELD OF THE INVENTION

The present invention relates to systems and methods for controlling managerial functions. More particularly, the present invention relates to the tracking, management, delivery, commitment, and confirmation of data in complex projects and agreements. Still more particularly, the present invention relates to the management of projects and agreements involving numerous inputs and outputs involving multiple people and locations.

### BACKGROUND OF THE INVENTION

In modern business activity, there has arisen a practice in which large complex projects or agreements are developed, negotiated, adjusted, and managed in a manner that involves input and output from a number of different participants. During initial stages of a project, one group of individuals is often tasked with defining and establishing the scope of the project. Once that stage of development has reached certain milestones, a new set of individuals may become involved regarding aspects such as financial demands, legal considerations, logistical requirements, and the like. Often large projects may involve governmental or quasi-governmental entities which have additional institutional needs that include reporting information to stakeholders or public interest groups. During the operation of an agreement both parties to the agreement typically appoint a management team. Several subparties may also be involved with respect to various aspects of the agreement. Often a large and complex agreement will span a significant period of time, even many years. During this time frame, there is often personnel turn over, as various individuals involved in the management or operation of the agreement change positions, move, retire, etc. Given each of these factors, there is a need for a method and system which allows teams of individuals to solve the management issues associated with large and complex agreements. Such methods and systems are called herein “commitment tracking,” meaning, inter alia, they afford proposing, tracking, reviewing, initiating, modifying and accepting each component part of a project or projects including individual “deliverables” that may be the responsibility of various parties, as well as “artifacts,” perhaps numerous, that are, in turn, discrete parts of the various deliverables, whose definitions, characteristics, progress, etc., are individually capable of being monitored.

The agreements described herein are also often characterized by a large geographical scope. For example, where a large company or a governmental or quasi-governmental entity is a party to an agreement, the agreement will likely engage various individuals and entities over a statewide, national, or even international breadth. Management may occur in one or more locations, manufacturing may occur in one or more different locations, and delivery may occur in still other locations. Decision makers may be located at each of these locations. Thus, there is a need for a commitment tracking system which allows for input, viewing, and analysis at multiple locations, by multiple individuals.

The following example will help to delineate the needs of entities involved in large complex projects and the deficiencies of existing management systems. Over time, insurance systems have become increasingly complex. For example, health insurance systems must deal with a plethora of health care service providers. Likewise, health care providers need to deal with a myriad of issues such as submittals, approvals, reimbursements, credits, and the like. A given payor or insurer additionally needs to manage input from regulators and management consultants. Once established, an agreement may call for periodic changes, such as annual rate changes and modifications in the scope of delivery. The development and negotiation of such a complex agreement can take a significant amount of time and cost a significant amount of money. The various businesses that comprise health insurance systems could be assisted and made more efficient by a system that allows for the quick development of an agreement, negotiation and approval of an agreement, and then the management and modification of the agreement. Very similar needs exist with respect to many other entities such as, for example, government programs, manufacturing systems, and construction programs, such as franchisee development, just to name a few. Thus, there is a need for a system that allows for input from multiple parties, even parties including geographically dispersed individuals, where the input is viewable by other parties, and where one or both parties can approve or disapprove of proposals.

There is also a need for improved commitment tracking functionality in systems that relate even to relatively smaller projects. For example, in dealings that relate to business issues, technical issues, or project management issues, an agreement may call for the creation and delivery of a commitment. A commitment is hereby a term that embodies any promise made between two or more parties. A commitment is often satisfied by one or more different deliverables such as the design of a physical good, the rendering of a service, the creation of a computer program, or the construction of a project. Typically there will be multiple such commitments required in the agreement. One issue that frequently arises is the precedence of commitments made. Which commitment should be delivered first? When precedence of commitments is unknown, determining whether and when each commitment has been successfully satisfied by the vendor is a daunting challenge. When commitments are equivalent, such as construction of the same building at multiple sites, there may be a further need for staggered delivery in order to satisfy cash flow needs, etc. And if commitments are found to contradict each other, there must be a means of resolving the conflict. Hence, there is a need for a system that allows multiple individuals at multiple locations to track commitments, set their precedence, resolve issues, and then acknowledge receipt and acceptance of the commitment as well as payment therefore.

Certain prior art systems have attempted to solve some of the issues identified herein. For example, various programs have been developed for tracing software requirements to software objects. However, these software requirements tracing programs are deficient in that they are specifically adapted to the software industry and are not readily applicable in non-software applications. Specifically, these programs can only trace software requirements, not commitments that can be met through non-software deliverables and artifacts. The requirements tracing programs are further deficient in that they utilize technical methodologies and modeling languages, making them impractical for non-technical users.

Additionally, various spreadsheet-based programs have been developed for use in project management. Spreadsheets, however, suffer from numerous limitations, as described below.

First, spreadsheet programs suffer from poor mapping of commitment precedence and poor mapping of commitments to artifacts. A spreadsheet program is a two-dimensional table. As such, a spreadsheet cannot map many-to-many relationships, as is necessary to document superseding or conflicting commitments. Similarly, spreadsheets suffer from poor mapping of commitments to artifacts. In complex projects there are scenarios in which one artifact satisfies many different commitments or one commitment requires multiple artifacts. As such, commitment-artifact relationships are another type of many-to-many relationship that cannot be properly mapped using a two-dimensional spreadsheet program.

Spreadsheet programs also suffer from poor security and a poor audit trail. Spreadsheet programs generally allow for restricted access to the spreadsheet through password protection. However, spreadsheet programs do not allow for varying levels of access based on the specific authorization of the user. They also lack the capacity to keep track of which users access the spreadsheet and the date and time of access. In order to provide proper security, there is a need for a system that provides multiple user capability and role-based security, which allows for identification of a user and specific update capability as assigned to the user by an administrator.

Further, spreadsheet programs do not keep track of changes or updates to the spreadsheet. In order to provide an audit functionality, there is a need for a system that provides multiple user capability and role-based security such that the system documents the date and time any past or present user logs on, any changes or updates made by the user, the date and time the change or update is made, any before and after value associated with the change or update, and the date and time the user logs off.

In a further aspect, the system must be made available to various entities who will be located in different locations. Spreadsheet programs do not have a multiple user capability and therefore do not provide that functionality. It is possible for multiple users to view a spreadsheet in a read-only capacity, however spreadsheet programs do not allow for multiple users each with update capability. As such, a spreadsheet program is limited in that it does not provide an interactive functionality. Thus, it is desirable to develop an interactive commitment tracking system that allows for multiple parties to exchange items such as: Request for Proposal (“RFP”), a Proposal, a Best and Final Offer (“BAFO”), various Contracts (including riders and amendments), and Change Orders.

In order to properly track the satisfaction of commitments a system must be capable of measuring the percent- completion with respect to projects and deliverables. Project management systems, such as those found in the prior art, generally measure the percent completion of a deliverable or a project based on the estimated completion of each deliverable artifact. Using the method commonly found in the prior art, a deliverable completion rate of 50% can be based on 100 total artifacts, each 50% complete. The earned value calculation method, as known in the prior art, is superior in that it measures the percent completion of a deliverable or a project based on the number of deliverable artifacts that are 100% complete. Using the more accurate earned value calculation, a deliverable completion rate of 50% means that 50% of 100 total artifacts have been completed. Hence, there is a need for a commitment tracking system that employs the more accurate earned value calculation in determining the percent completion of a project or a deliverable.

The prior art systems also suffer from limitations in their ability to bridge various landmarks of a project. What is needed is a comprehensive solution that offers control and input to a project from conception, through its entire life, to completion and termination. The prior art does not offer such a solution.

There is a need for an improved method and system for tracking commitments and managing projects of varying complexity. It is desirable to develop a management system that allows for input from multiple parties at varying locations and times. It is also desirable that an improved commitment tracking system and method allow for the integrated management of a project from proposal, through negotiation, final agreement, and contract maintenance. It is further desirable to provide an improved system and method for tracking the satisfaction of commitments that can allow for interactive communication with various parties and components of the overall project.. Still further, it is desirable to develop a system that employs the earned value calculation method for determining percent completion. Finally, it is desirable to provide a management system and method that fits easily into existing computer hardware and software systems commonly used in business management. The present invention addresses one or more of these needs.

### SUMMARY OF THE INVENTION

In accordance with one aspect of the present invention, and by way of example only, there is provided a commitment tracking system that allows for interactive input and output from multiple users including vendors and customers. The commitment tracking system allows the parties to a project to view the development of the project, its negotiation, finalization, and implementation with transparency. The commitment tracking system allows a first party to identify individual commitments from multiple commitment sources. A second party can likewise populate a work breakdown structure that includes projects, deliverables, and artifacts. The parties can link individual artifacts with commitments so as to define the agreement and monitor progress and/or changes to the agreement.

In a further embodiment, by way of example only, there is provided a method for tracking commitments having a first party and a second party, wherein the first party includes agents, possibly at a plurality of different locations, and wherein the second party includes agents, possibly at a plurality of different locations, the method comprising the steps of: the first party providing data to establish commitment sources and a list of commitments; the second party providing data to establish a statement of work, list of deliverables, and list of artifacts; the second party assigning an artifact to a deliverable; the first party linking commitments to artifacts; the first party documenting acceptance criteria for artifacts; the second party assigning artifacts to commitments; and the first party accepting artifacts. Additionally the first party may reject or elaborate an artifact. The method may further comprise the step of adding additional artifacts and adding additional commitments.

In a further embodiment, and still by way of example only, there is provided a commitment tracking system for allowing interactive cooperation between a vendor and a contracted party regarding artifacts and commitments. The system comprises a commitment tracking system home page that includes: a commitment sources symbol with an active link to a commitment sources list window wherein the commitment sources list window displays information regarding commitment sources; a commitments symbol with an active link to a commitments list window wherein the commitments list window displays information from individual commitments categorized by commitment sources; a project symbol providing an active link to a project list window; a deliverables symbol providing an active link to a deliverables list window wherein the deliverables list window displays information regarding deliverables; and an artifacts symbol providing an active link to an artifacts list window wherein the artifacts list window displays information regarding artifacts. The system is configured such that the artifacts can be documented so as to comprise each deliverable; the artifacts can be assigned to a commitment; a commitment can be linked to an artifact; and an artifact can be accepted or rejected. The system may also include an artifact details window linked to the artifact list window, an artifact-commitment window linked to the artifact list window, an artifact acceptance window linked to the artifact list window, an artifact vendor submission window linked to the artifact list window, a commitment-artifacts window linked to a commitment list window, and a commitment details window linked to the commitment list window.

In still a further embodiment, and still by way of example only, there is provided a method for tracking the satisfaction of commitments having at least a first party and a second party, wherein the first party potentially includes agents at a plurality of different locations and wherein the second party potentially includes agents at a plurality of different locations. The method includes the steps of: one or more agents of the first party providing data to establish commitment sources by inputting the data into a commitment sources list window; one or more agents of the first party providing data to establish a list of commitments by inputting the data into a commitments list window; one or more agents of the second party providing data to establish a project list by inputting the data into a project list window; one or more agents of the second party providing data to establish a list of deliverables by inputting the data into a deliverables list window; one or more agents of the second party providing data to establish a list of artifacts by inputting the data into an artifacts list window; one or more agents of the second party assigning an artifact to a deliverable within the artifacts list window; one or more agents of the first party linking commitments to artifacts within the commitment-artifacts window; one or more agents of the first party documenting acceptance criteria for artifacts within the artifact details window; one or more agents of the second party assigning artifacts to commitments within the artifact-commitments window; and one or more agents of the first party accepting artifacts within the artifact acceptance window. The step of providing data to establish a list of artifacts may further include providing an artifact identification, an artifact description, an artifact type, and a submission due date. The step of providing data to establish a list of deliverables may further include providing a deliverable identification, a deliverable description, a project, and a deliverable stakeholder. The step of providing data to establish a commitment list may further include providing a commitment identification, a commitment source, a commitment type, a source section, and a commitment description. The step of providing data to establish a commitment source list may further include providing a commitment source, a commitment precedence, a lock option, and a lock date. Additionally, the method may include a step in which the second party reviews and agrees to be bound to the commitment list provided by the first party, and the first party likewise reviews and agrees to be bound to the artifact list provided by the second party.

Other independent features and advantages of the commitment tracking system will become apparent from the following detailed description, taken in conjunction with the accompanying drawings which illustrate, by way of example, the principles of the invention.

### BRIEF DESCRIPTION OF THE DRAWINGS

FIG. 1 is a schematic layout of a commitment tracking system, according to an embodiment of the present invention;

FIG. 2 is a screen :shot of a commitment tracking system home page, according to an embodiment of the present invention;

FIG. 3 is a screen shot of a commitment source list window, according to an embodiment of the present invention;

FIG. 4 is a screen shot of a commitment list window, according to an embodiment of the present invention;

FIG. 5 is a screen shot of a commitment details window, according to an embodiment of the present invention;

FIG. 6 is a screen shot of a supersede this commitment window, according to an embodiment of the present invention;

FIG. 7 is a screen shot of a commitment-artifacts window, according to an embodiment of the present invention;

FIG. 8 is a screen shot of an artifacts list window, according to an embodiment of the present invention;

FIG. 9 is a screen shot of an artifact details window, according to an embodiment of the present invention;

FIG. 10 is a screen shot of an artifact comment log window, according to an embodiment of the present invention;

FIG. 11 is a screen shot of an artifact acceptance window, according to an embodiment of the present invention;

FIG. 12 is a screen shot of a project list window, according to an embodiment of the present invention;

FIG. 13 is a screen shot of a deliverables list window, according to an embodiment of the present invention;

FIG. 14 is a screen shot of an artifact-commitments window, according to an embodiment of the present invention; and

FIG. 15 is a screen shot of an artifact vendor submission window, according to an embodiment of the present invention.

### LIST OF REFERENCE NUMBERS

The following reference numbers are noted on the attached figures.
10 commitment tracking system
11 commitment sources
12 commitments
14 supersede functionality
15 work breakdown structure
16 projects
17 deliverables
18 artifacts
20 commitment tracking system home page
21 commitment sources symbol
22 commitments symbol
26 projects symbol
27 deliverables symbol
28 artifacts symbol
30 commitment source list window
31 commitment source list
32 commitment source description
33 commitment source precedence
34 commitment source lockdown
35 commitment source lock date
36 drill down button
40 commitment list window
41 commitment identification
43 commitment type column
44 source section
45 commitment owner
46 commitment description
47 hide superseded button
48 more details button
49 supersede this commitment button
50 commitment artifacts button
51 commitment details window
52 commitments comments box
53 table of superseding commitments
54 relationship between commitments
55 predecessor commitment identification
56 description of predecessor commitment
57 show all button
60 supersede this commitment window
61 box for superseding a commitment
70 commitment-artifacts window
71 commitment-artifacts table
72 relation of commitment to artifact
73 artifact details button
80 artifact list window
81 artifact identification
82 artifact description
83 artifact type
84 artifact initial submission due date
85 artifact author
86 artifact status
87 artifact acceptance date
88 artifact owner
89 artifact commitments button
90 artifact vendor submit button
91 artifact comment log button
92 relationship between artifact and deliverable
93 accept artifact button
100 artifact details window
101 artifact acceptance criteria
102 artifact comments box
110 artifact comment log window
111 summary of comments posted
120 artifact acceptance window
121 artifact acceptance cosigners button
122 sign-off form button
130 projects list window
131 project name
132 project description
133 project manager
134 project planned completion date
135 project budget
136 project earned value calculation
137 schedule variance
140 deliverables list window
141 deliverable identification
142 deliverable description
143 project comprising the deliverable
144 deliverable stakeholder
145 deliverable planned completion date
146 deliverable budget
147 deliverable earned value calculation
150 artifact-commitments window
151 artifact-commitments table
152 relation of artifact to commitment
153 commitment details button
160 artifact vendor submission window
161 submission cycle
162 artifact due date
163 actual date of artifact submission
164 deadline for review of submission

### DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention. Reference will now be made in detail to exemplary embodiments of the invention, examples of which are illustrated in the accompanying drawings. Wherever possible, common reference numbers are used throughout the multiple figures.

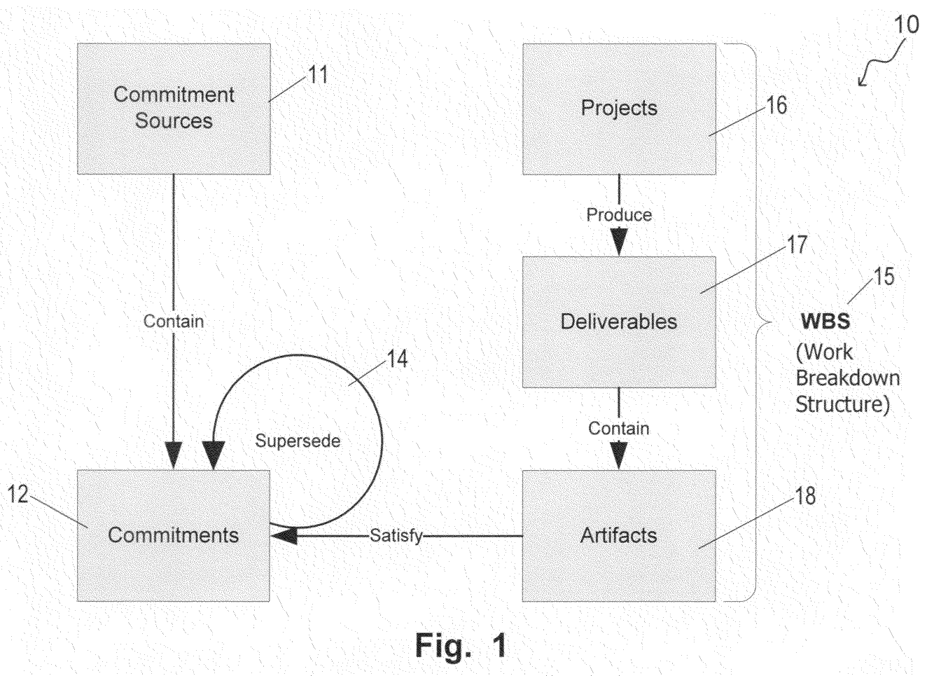

Referring initially to FIG. 1 there is shown a schematic diagram illustrating the elements of a commitment tracking system 10 according to a preferred embodiment. Implemented in computer hardware and software, the commitment tracking system 10 includes a commitment organization structure intended for use by a first party, and a work breakdown structure 15 intended for use by a second party. The commitment organization portion includes an input for commitment sources 11. The input for commitment sources populates a list of commitments 12. A supersede functionality 14 allows the individual commitments within the list of commitments 12 to be updated or superseded.

The commitment tracking system 10 further includes the work breakdown structure 15, which is designed so as to facilitate the development and management of various items that a second party would typically prepare for delivery to a first party. Thus, the work breakdown structure 15 includes a list of one or more projects 16, each of which further comprises a list of one or more deliverables 17 that make up each project. The list of deliverables 17 further includes individual artifacts 18. Connected to each artifact 18 is a tender and acceptance functionality which allows a second party to submit an artifact 18 and allows the first party to accept or reject the tendered artifact. If rejected, a comment functionality allows the first party to identify the reasons for rejection.

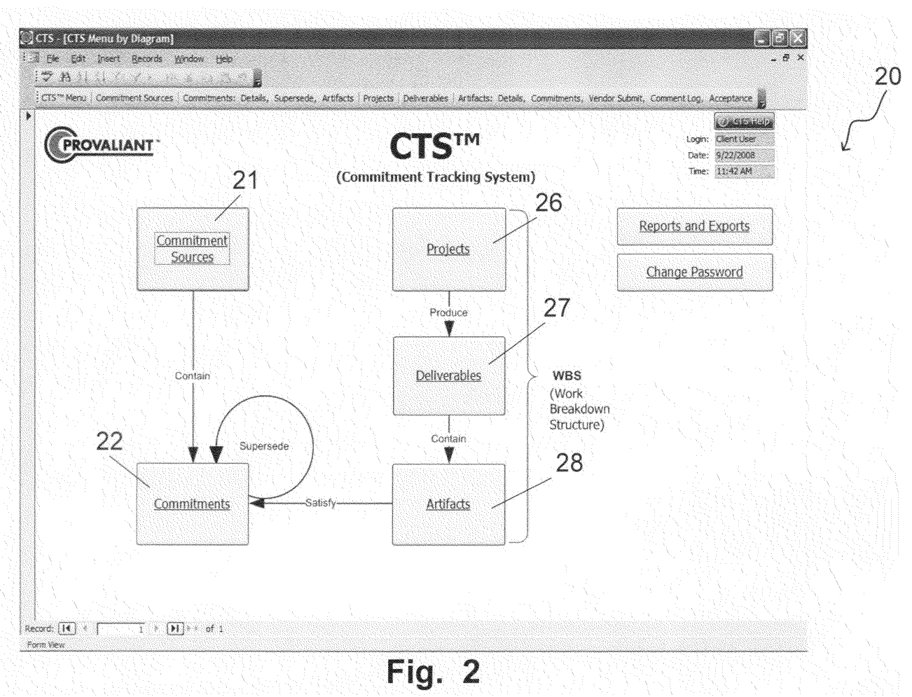

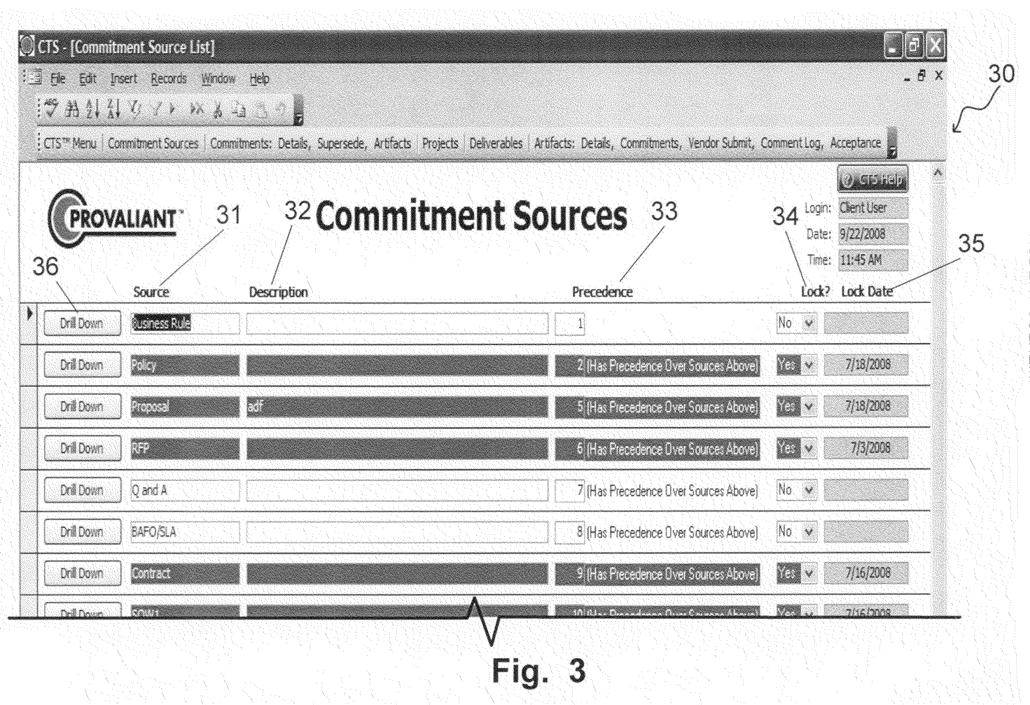

As shown in FIG. 2, the schematic of the commitment tracking system 10 also serves as a commitment tracking system home page 20, for presentation on a computer screen, for example. Therein a commitment sources symbol 21, a commitments symbol 22, a projects symbol 26, a deliverables symbol 27, and an artifacts symbol 28 are active links. For example, clicking on the commitment sources symbol 21, with a computer mouse or other activator, leads to a commitment source list window 30, as shown in FIG. 3. Various user interface devices known in the art can be used to effect the operations described. These include touch screens or mouse activated icons, highlighted or active differently colored or underscored terms or labels, voice or keyboard commands, or any other user interface as known in the art.

In a preferred embodiment the commitment tracking system 10 may be implemented using an access interface such as Microsoft Access available from Microsoft Corporation, Redmond, Wash. Those familiar with this or similar programming tools will be readily able to accomplish the attributes and functioning of the described embodiments of this invention as it is described on the basis of various screen shots, interactive symbols or icons and the actions that result from activation of those. The interface allows for simultaneous access and update by multiple users. These users typically are networked through a global network such as the internet or through a wide area network. All users can view: the commitment sources 11, the commitments 12, the work breakdown structure 15, and the details associated with each. Only specifically authorized users, generally agents of the first party, can update or supersede the individual commitments 14. Only authorized agents, generally agents of the second party, can update the work breakdown structure 15. Authorized agents of the first party can accept the artifacts 18 once they have been tendered. Input and changes to the input fields are logged and archived so as to show all user updates and the date of each.

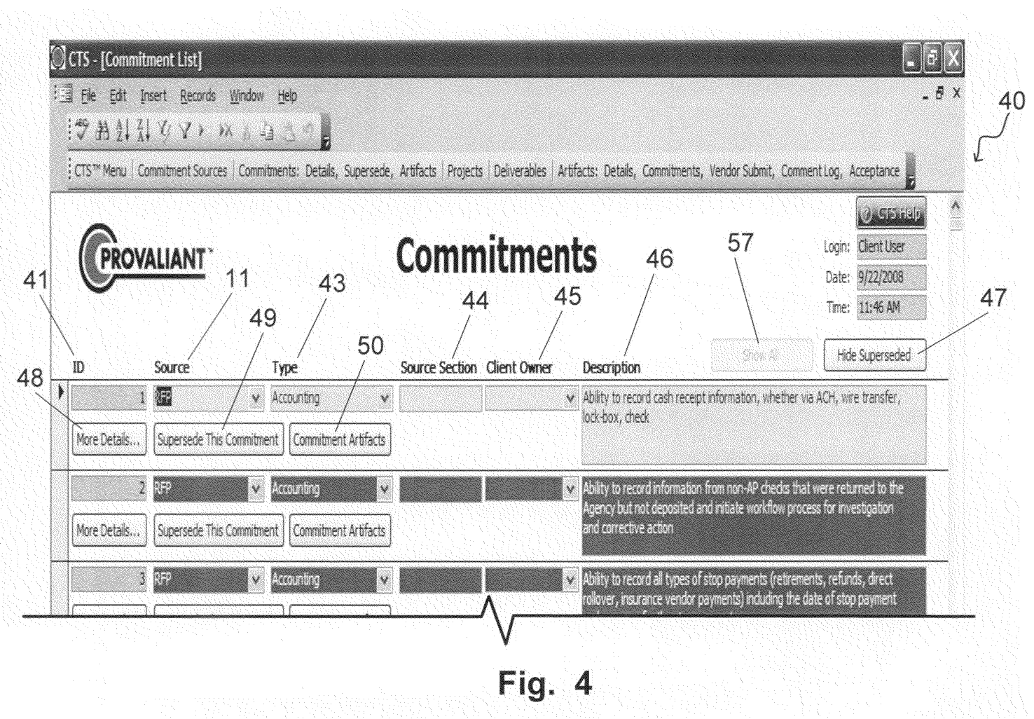

Referring next to FIG. 3, there is shown an exemplary embodiment of the commitment source list window 30. The commitment source list window 30 comprises a plurality of individual rows containing individual commitment source entries. The following information is provided for each commitment source 31 in column format: a commitment source list 31, wherein the individual commitment sources 11 are identified; a commitment source description 32; a commitment source precedence 33, which establishes the precedence of each individual commitment source 11; and a commitment source lockdown 34, which allows the precedence 33 and commitment source 11 to be locked. Further, the commitment source list page 30 may display other information including a lock date 35, notes, and a user log. The order of precedence 33 determines which commitment sources 11 can supersede other commitment sources 11. Once a commitment source 11 has been finalized and should no longer be updated, the user can lock the source by selecting that option in the commitment source lockdown column 34. Once locked, a commitment source 11 cannot be altered by either party. In usage, a commitment source 11 would typically be locked, for example, in the following circumstances: 1) when an RFP has been released, the RFP source is locked. 2) When a proposal is accepted, the proposal source is locked. 3) When a contract is signed, the contract source is locked. For each commitment source 11 listed in the commitment source list window 30 there is a “drill down” button 36, which generally allows the user to view additional information about a particular entry. The drill down button 36 located in the window 30, allows a user to access the commitments 12 and other information associated with each commitment source 11, as shown in FIG. 4 and discussed below.

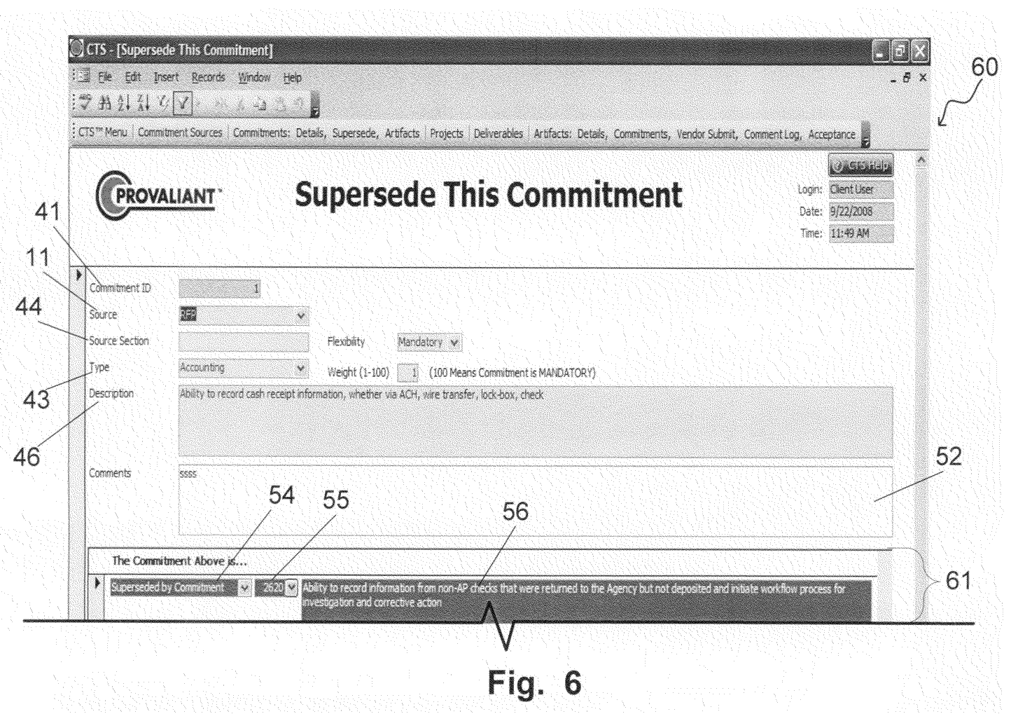

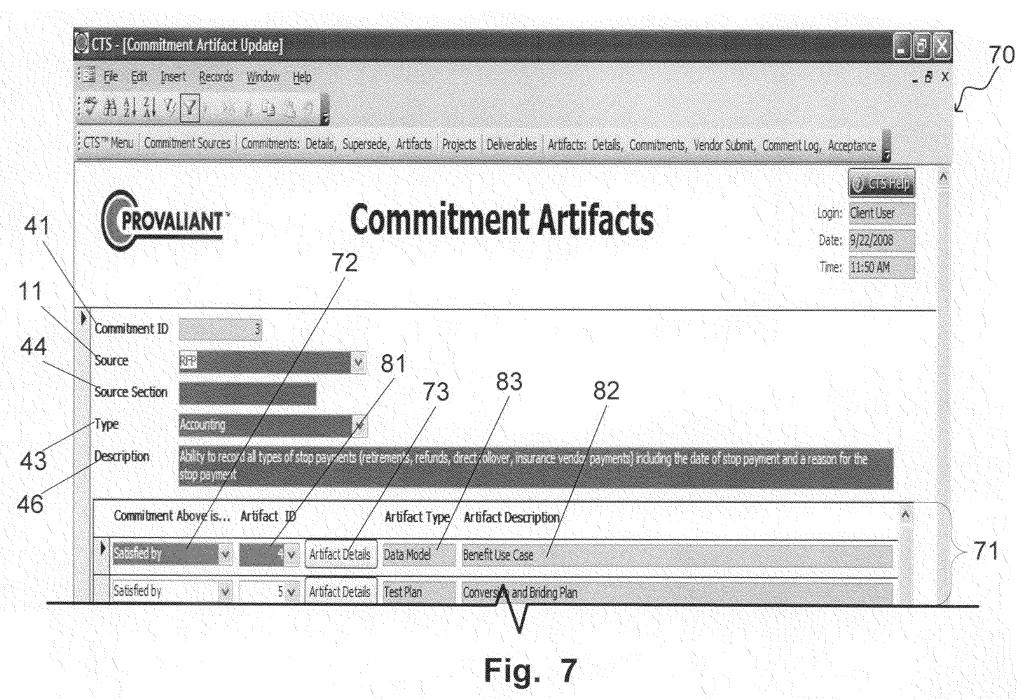

Referring next to FIG. 4, the screenshot illustrates a commitment list window 40 whereby individual commitments 12 are listed for access, review, and interaction by a user. The format of the commitment list window 40 is similar to the format of the commitment source list window 30. The commitment list window 40 includes a series of rows that relate to individual commitments 12. Each column contains further information related to each commitment 12. In the preferred embodiment a first column is a commitment source list 31, which provides the source 11 of a given commitment 12. A following column contains a commitment identification 41, which is an identification number assigned to the commitment. Further columns contain a commitment type 43, which varies from embodiment to embodiment; a source section 44, which is the location of the commitment 12 within the source 11; and a commitment owner 45, which is typically an agent of the first party. Still further is a column containing a commitment description 46 which provides descriptive information pertaining to each commitment 12. A button 47 toggles between “hide superseded,” as shown, and “show all.” Clicking on “hide superseded” allows only those commitments 12 that have been superseded to be viewed, clicking on “show all” 57 allows a user to view all commitments 12. A supersede this commitment button 49 takes the user to a supersede this commitment window 60, as shown in FIG. 6. A commitment artifacts button 50 takes the user to a commitment-artifacts window 70, as shown in FIG. 7. It is noted that the commitment list window 40 of FIG. 3 can also be accessed by clicking the commitment symbol 22 on the commitment tracking system home page 20 in FIG. 2.

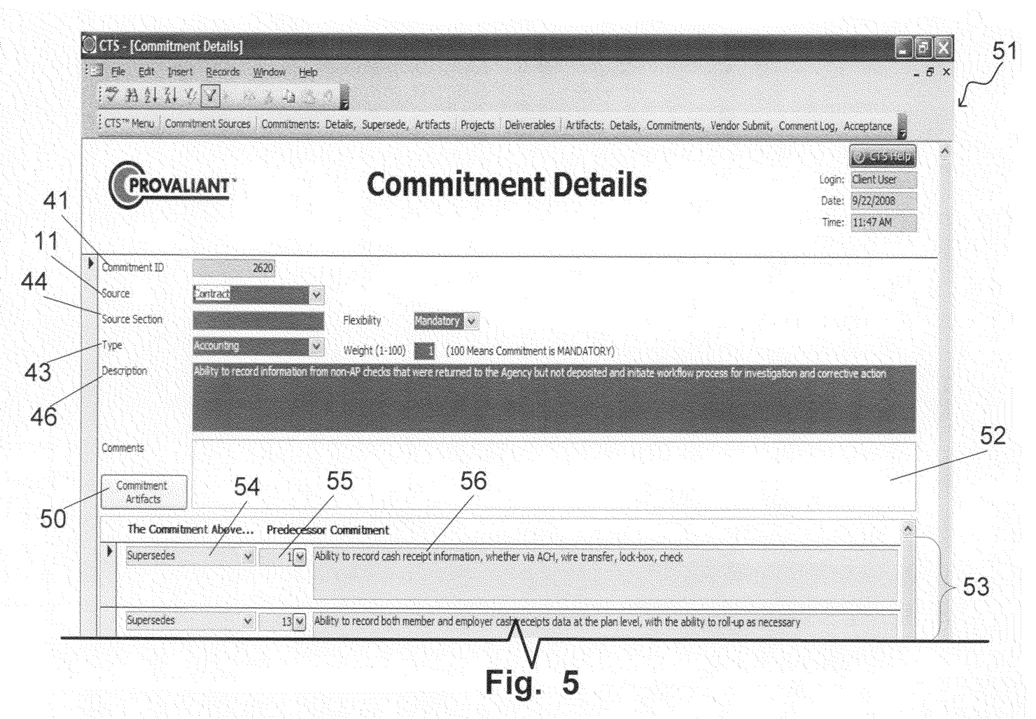

In FIG. 4 it is noted that the commitment list window 40 includes a more details button 48 in each row. The more details button 48 allows a user to access a commitment details window 51 as shown in the exemplary embodiment of FIG. 5. The commitment details window 51 allows for user interaction with each of the details associated with a particular commitment 12. A user can enter or update information on the commitment details window 51. The commitment details window 51 includes the following information for each commitment 12: the commitment identification 41, the commitment source 11, the source section 44, the commitment type 43, and the commitment description 46. Further, a commitment comments box 52 allows for entry of comments by a user. The commitment details window 51 further includes a table of superseding commitments 53, for use in determining the relationship of this particular commitment 12 to other commitments 12. The table of superseding commitments 53 further contains a relationship between commitments 54, a predecessor commitment identification 55, and a description of the predecessor commitment 56. The commitment artifacts button 50 allows the user to move to the commitment-artifacts window 70, as shown in FIG. 7.

Referring next to FIG. 6, there is shown a supersede this commitment window 60, which is accessed by clicking the supersede this commitment button 49 on the commitment list window 40. The supersede this commitment window 60 allows the user, generally an agent of the first party, to change the relationship between commitments 12. The window 60 includes information about the commitment to be superseded, including: the commitment identification 41, the commitment source 11, the source section 44, the commitment type 43, the commitment description 46, and the commitment comments box 52. Further the supersede this commitment window 60 includes a box for superseding a commitment 61, which further includes the relationship between commitments 54, the predecessor commitment identification 55, and the description of predecessor commitment 56.

It is noted that the commitment details window 51, shown in FIG. 5, and the commitment list window 40, shown in FIG. 4, both include the commitment artifacts button 50. The commitment artifacts button 50 opens a commitment-artifacts window 70, shown in FIG. 7. The commitments-artifacts window 70 is one means by which users interact by showing the tender of an artifact, its acceptance, elaboration, or rejection, and provide descriptions thereof. The commitments artifacts window 70 includes relevant information including the commitment identification 41, the commitment source 11, the source section 44, the commitment type 43, and the commitment description 46. Additionally, there is provided a commitments-artifacts table 71. The columns of the commitment-artifacts table 71 display a relation of commitment to artifact 72, an artifact identification 81, an artifact type 83, an artifact description 82, and an artifact details button 73.

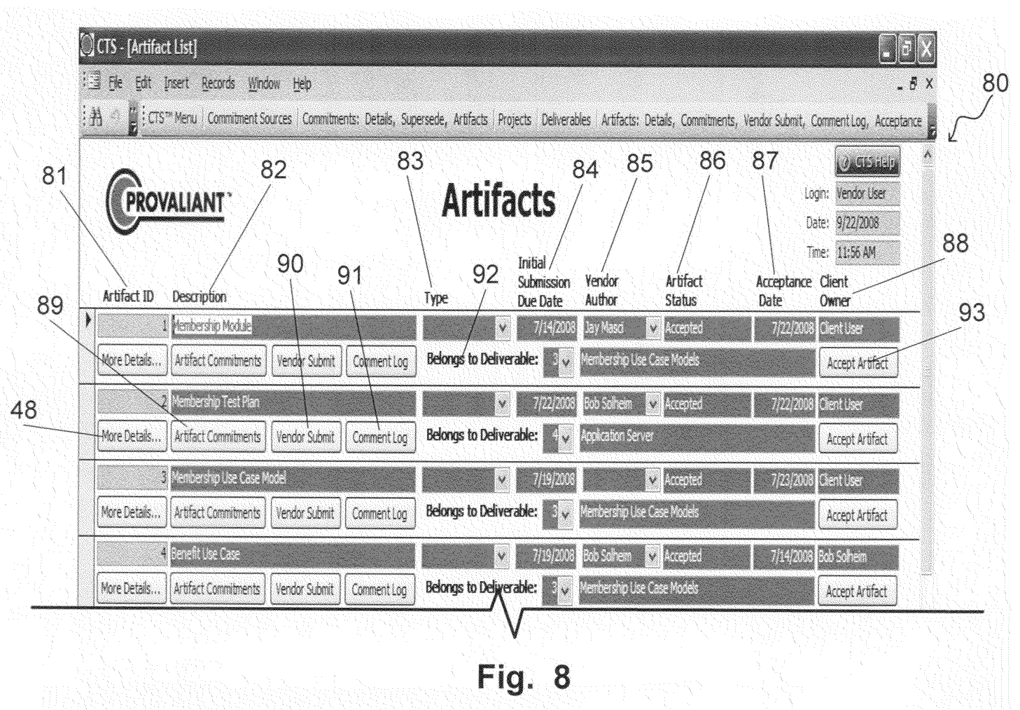

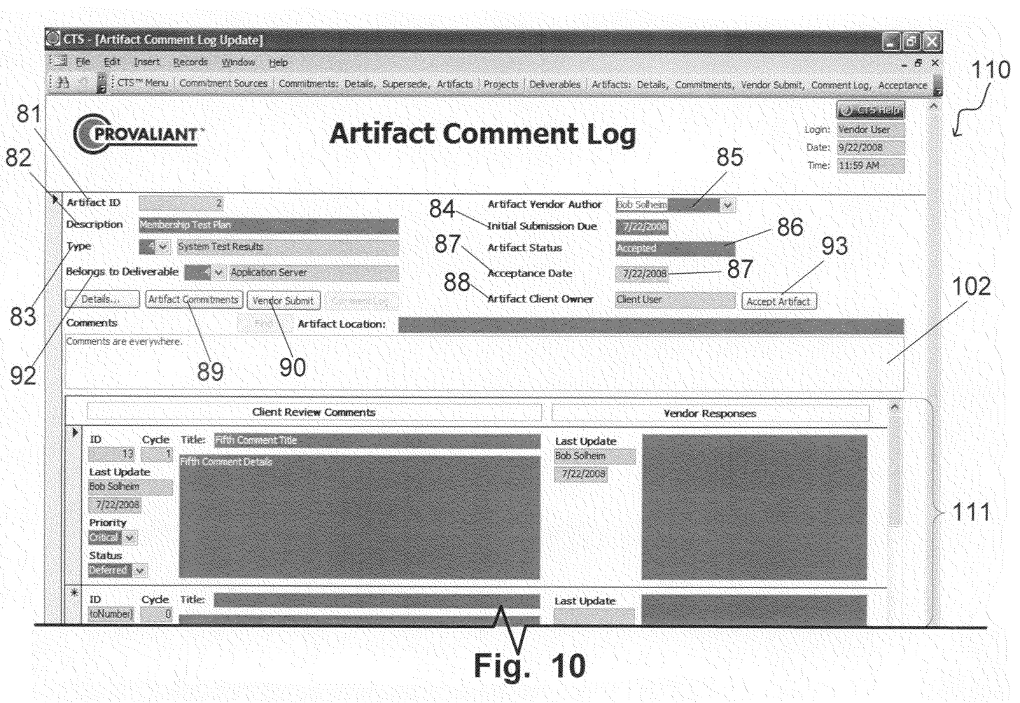

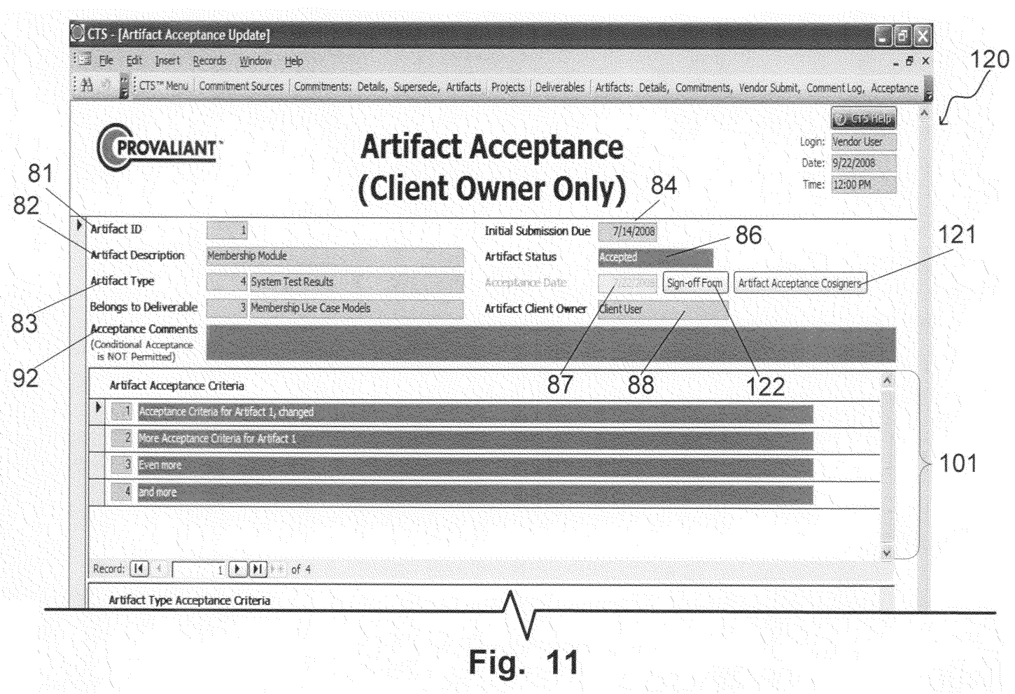

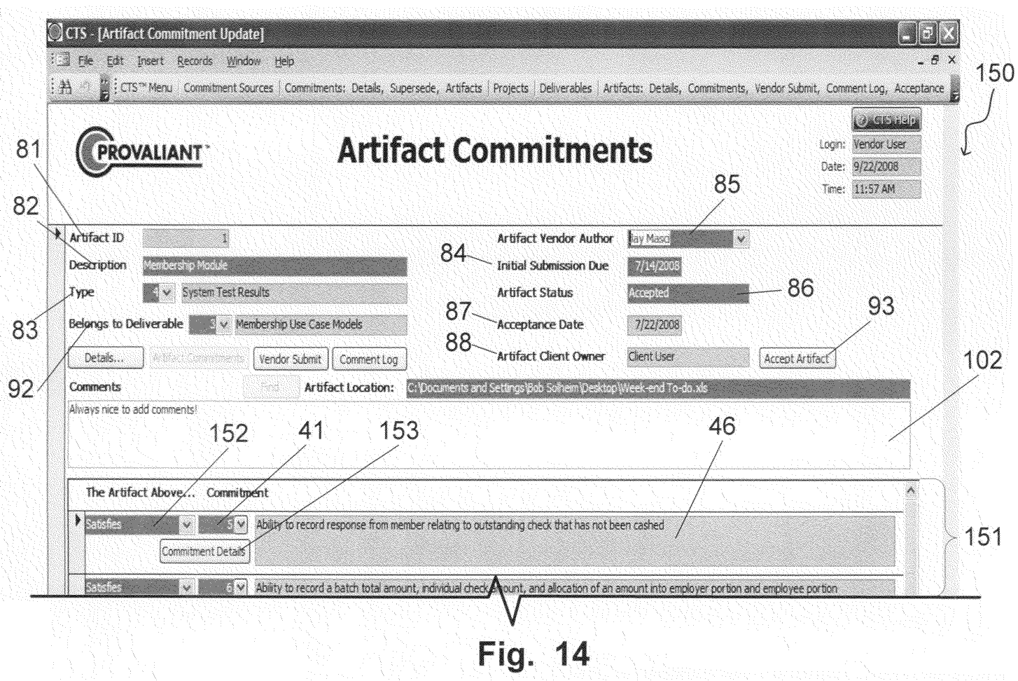

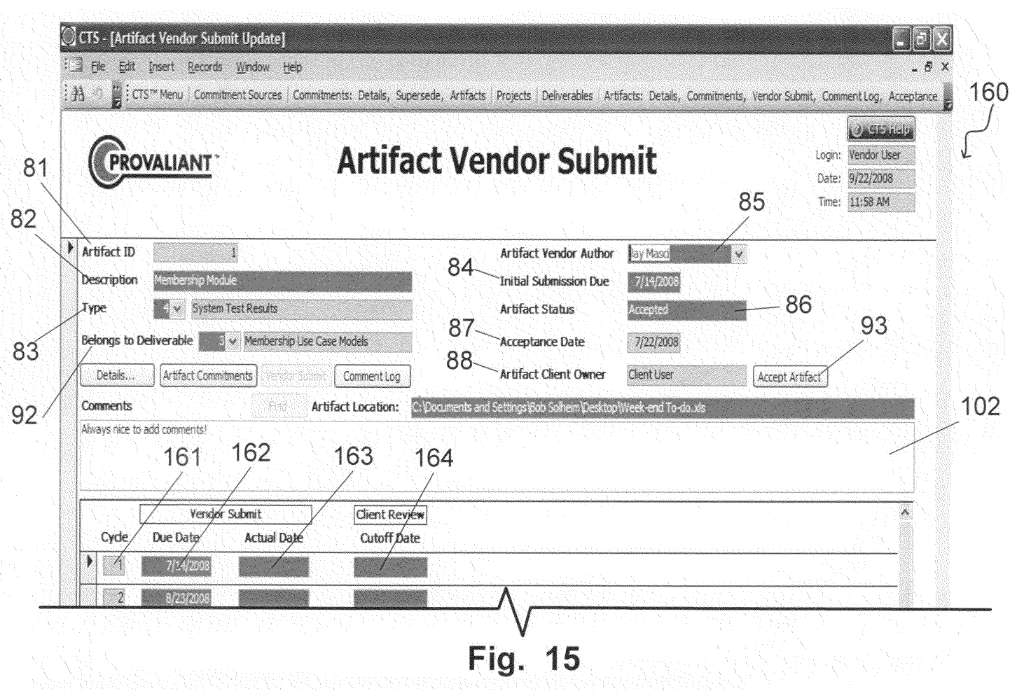

Referring next to FIG. 8 there is shown an artifact list window 80 according to a preferred embodiment. The artifact list window 80 provides a table of information, including rows which display information regarding each artifact 18. In column format, the table displays the artifact identification 81, the artifact description 82, the artifact type 83, an artifact initial submission due date 84, an artifact author 85, an artifact status 86, an artifact acceptance date 87, an artifact owner 88, and the relationship between the artifact and the deliverable 92. A more details button 48 is also preferably provided in each row 61, to provide the user with a means to access detail related to each artifact 18. An artifact comment log button 91 allows a user to access an artifact comment log window 110, as shown in FIG. 10. Still referring to FIG. 8, the artifact list window 80 further contains an artifact commitments button 89, which allows a user to view an artifact-commitments window 150, as shown in FIG. 14. The artifact list window 80, of FIG. 8, finally includes an accept artifact button 93, which allows the user to view the artifact acceptance window 120, as shown in FIG. 11. The vendor submit button 90 provides a link to an artifact vendor submission window 160, as shown in FIG. 15.

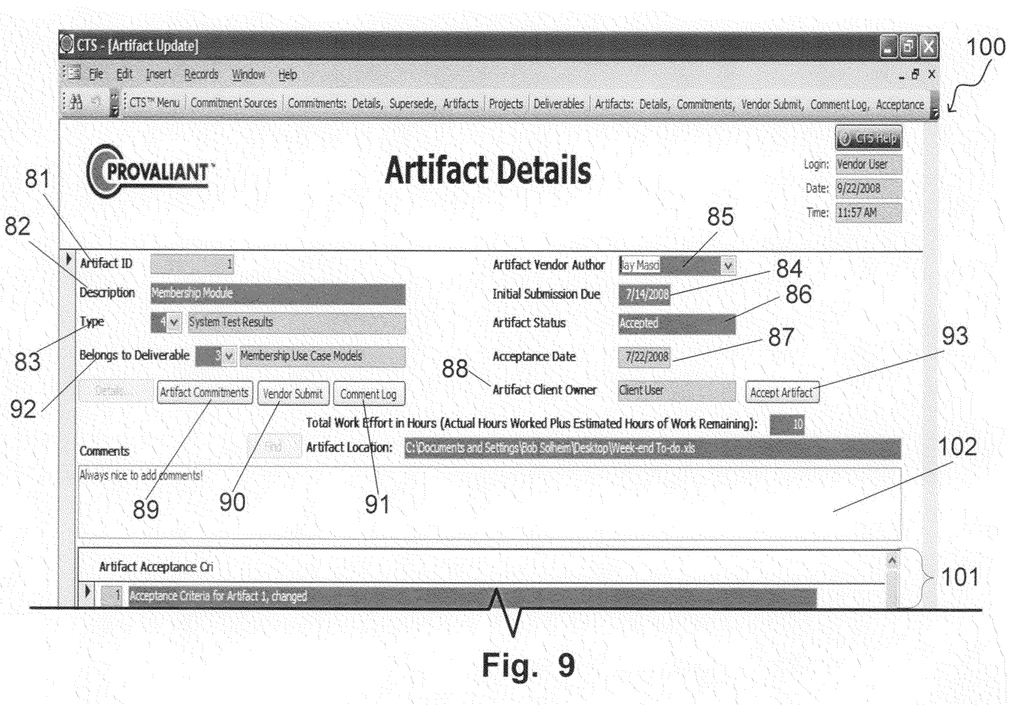

Referring next to FIG. 9 there is shown an artifact details window 100 according to a preferred embodiment. The purpose of this page is to display relevant information related to an individual artifact 18. From this window 100 it is possible to access artifact acceptance criteria 101. Additionally a user can enter comments in the artifact comments box 102.

FIG. 10 shows the artifact comment log window 120, which is accessed by the artifact comment log button 91 of either the artifact list window 80 of FIG. 8 or the artifact details window of FIG. 9. In addition to relevant information about each artifact 18, the artifact comment log window 120 includes a summary of comments posted by users 111.

In a preferred embodiment, activation of the accept artifact button 93 will activate the artifact acceptance window 120, shown in FIG. 11. The first party has the decision-making authority regarding whether to accept a tendered artifact 18, and thus the preferred embodiment is designed such the first party has the ability to accept an artifact 18 in the artifact acceptance window 120. The artifact acceptance window 120 includes relevant artifact information, including the artifact identification 81, the artifact description 82, the artifact type 83, the relationship between artifact and deliverable 92, the artifact initial submission due date 84, the artifact status 86, and the artifact owner 88. Additionally the artifact acceptance criteria 101 is displayed in a list. An artifact acceptance cosigners button 121 allows for recordation of additional individuals involved in accepting an artifact. If a physical signature is required for acceptance of an artifact, a sign-off form button 122 allows a user to print the sign-off form. When an agent of the first party accepts an artifact, an acceptance date is entered in the artifact acceptance date box 87. Acceptance of an artifact within the artifact acceptance window 120 causes indication of artifact acceptance throughout the system.

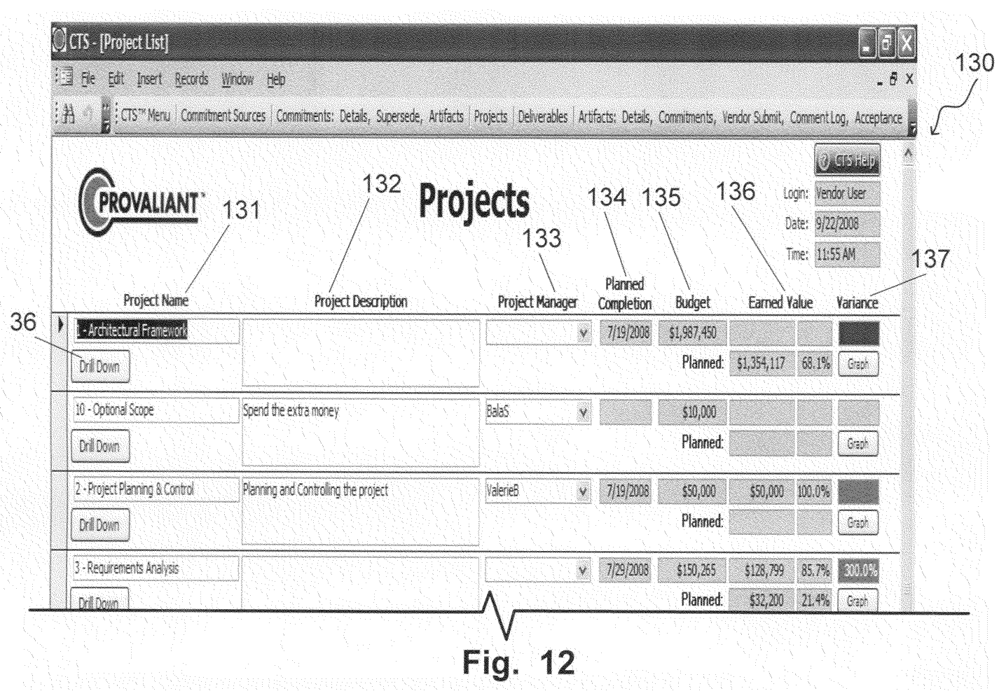

Referring next to FIG. 12 there is shown a preferred embodiment of a project list window 130. The project list window 130 can be accessed by activating the project symbol 26 on commitment tracking system home page 20, as shown in FIG. 2. The project list window 130 provides a table of information, including rows displaying information about individual projects 16. In column format, the table displays a project name 131, a project description 132, a project manager 133, a project planned completion date 134, a project budget 135, a project earned value calculation 136, and a variance 137. Preferably, a drill down button 36 allows further access to details underlying each project.

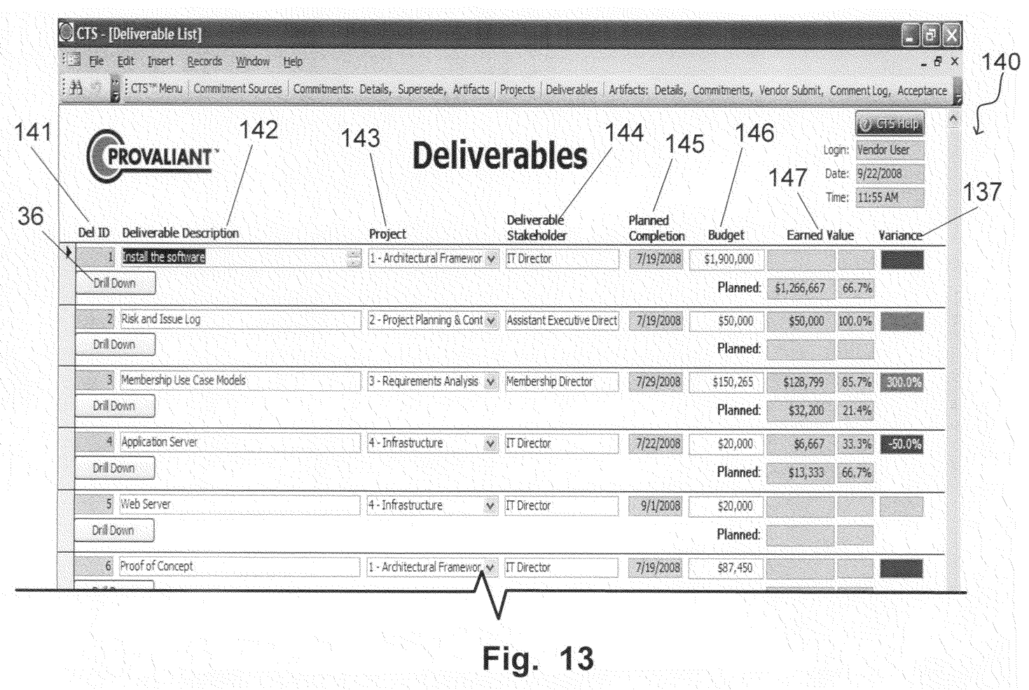

The drill down button 36 will populate a deliverable list window 140 shown in FIG. 13. It is further noted that the deliverable list window 140 can also be accessed by activating the deliverable symbol 27 on the commitment tracking system home page 20, as shown in FIG. 2. The deliverable list window 140 comprises a table. Each row displays information pertaining to a particular deliverable 17. The following detailed information for each deliverable is categorized in columns: a deliverable identification 141 which provides an identification number for each deliverable; a deliverable description 142 which provides descriptive information; a project comprising the deliverable 143; a deliverable stakeholder 144 which identifies an individual, office, or organization with responsibility for the deliverable; a deliverable planned completion date 145; a deliverable budget 146; a deliverable earned value calculation 147, as is known in the art; and a schedule variance 137, which is calculated by dividing the difference in the actual earned value and the planned earned value by the planned earned value. A drill down button 36 allows for further access to information about each deliverable.

Activation of the drill down button 36 opens the artifact list window 80, as shown in FIG. 8, which comprises a list containing each artifact 18 associated with the deliverable 17. Additionally, activation of the artifact symbol 28 on the commitment tracking system home page 20 displays the artifact list window 80 as shown in FIG. 8. As discussed previously, the artifact list window 80 also displays all information pertaining to each artifact 18 in a table format.

Activation of the more details button 48 in the artifact list window 80 causes the artifact details window 100 to be displayed, as shown in FIG. 9. The artifact detail window 100 will display information related to each artifact 18. As discussed previously, the artifact detail window 100 additionally includes the artifact acceptance criteria 101, which is the information that is required in order for the artifact to be accepted. Additionally in the preferred embodiment, the artifact details window 100 includes the artifact commitments button 89, which allows a user to access the artifact-commitment window 150, as shown in FIG. 14.

Referring now to FIG. 14 there is shown a preferred embodiment of the artifact-commitment window 150. The artifact-commitment window 150 displays general artifact information such as the artifact identification 81, the artifact type 83, the artifact description 82, the relationship between artifact and deliverable 92, the author 85, the initial submission due date 84, the artifact status 86, the acceptance date 87, the artifact owner 88, and the like. The artifact commitments window 150 further includes an artifact-commitments table 151, which displays a list of commitments associated with the specified artifact. The artifact-commitments table 151 includes a relation of artifact to commitment 152, the commitment identification 41, the commitment description 46, and a commitment details button 153, which allows a user to view the commitment details window 51 associated with the specified commitment 12. Also the accept artifact button 131 allows for acceptance of the artifact by the first party. A vendor submit button 90 allows the user to view the artifact vendor submission window 160, as shown in FIG. 15.

The artifact vendor submission window 160 in FIG. 15 is the means by which a second party submits an artifact 18 for review and acceptance or rejection by the first party. The artifact vendor submission window 160 includes all relevant artifact information including the artifact identification 81, the artifact description 82, the relationship between artifact and deliverable 92, and the like. The window 160 additionally includes a submission cycle 161, an artifact due date 162, an actual date of artifact submission 163, and a deadline for review of the submission 164 by the first party.

Having described the commitment tracking system from a structural and schematic standpoint, a method of using the system will now be described. The commitment tracking system is preferably provided on a software platform that is available to all involved parties such as vendors, suppliers, contracting parties, agencies, and stakeholders. Thus any user would have concurrent access to all system information. Preferably the commitment tracking system may be accessed by computer. The commitment tracking program may be provided to the computer through a variety of means such as through a dedicated hosting site, through the internet, or through an intranet system. Communication means such as wired or wireless connections may be provided among computers.

In one embodiment a project begins when the involved parties, a vendor and an agency for example, input the elements of the system for which they have initial responsibility, into the above described embodiment. The vendor would have responsibility for identifying the projects, documenting the deliverables that comprise each project, documenting the artifacts that comprise each deliverable, and assigning artifacts to the commitments that they satisfy or elaborate upon. The final step, assigning artifacts, typically occurs after the parties have entered a contract or an agreement, however, it is not necessary to the functionality of the system.

The agency would have responsibility for identifying the commitment sources, documenting the commitments, documenting the relationship between the commitments, linking the commitments to the artifacts, documenting the acceptance criteria for the artifacts, accepting the artifacts, and populating an RFP template.

To further elaborate on the above embodiment, for purposes of clarity, the following example is provided. The vendor's project list 130 includes the following phases of development: preparation and tender of an alpha program, testing of an alpha program, and preparation and tender of a beta program. It is contemplated that this three-phased project would occur in timed phases of six months for the first phase, two months for the second phase, and three months for the third phase. The agency would establish the commitments such as the delivery terms, the pricing, the number of copies, the hardware, the software, the programming language, etc. The agency could propose any relevant information for the normal preparation and development of a software product. Likewise, the vendor would propose its own terms by defining the deliverables and the artifacts that comprise each project. This may include information such as aspects of the software being developed, the database structure, the functionality, etc. These terms would be visible to each party. Ultimately, when an acceptable commitment list 40 and corresponding work breakdown structure 15 has been populated and exchanged using the system, the agency can document the acceptance criteria 101 for each artifact 18. In a following step, the vendor would undertake the work in the three phases. As each aspect of a project is completed, the vendor would assign a completed artifact 18 to the commitment 12 that it satisfies or elaborates upon. The agency can then accept or reject the tendered artifact.

In this manner, the system can efficiently handle projects of large, even undefined scope involving several parties, in widely dispersed areas, wherein many individuals in many positions (including changing individuals in each respective position) are participants in the project. It is noted, for example, that an artifact list 80 or a deliverable list 140 can be expanded by simply adding additional artifacts 18 and deliverables 17 to the previously established list. In other words, the parties can begin a project understanding it to include a set of ten artifacts 18 linked with ten commitments 12 (or some different number thereof). Over time, however, the parties may wish to add additional artifacts 18 and commitments 12 that go beyond the originally established lists. The system allows the parties that opportunity. Or, alternatively, the parties may wish to delete or modify previously shown artifacts 18 and commitments 12, and the system provides that functionality as well.

The overall structure of an exemplary tracking system has now been described. However, in operation the system allows for a level of access and flexibility which makes it advantageously suited to large business projects. The agency or a first party is responsible for identifying the valid commitment sources 11. Further the agency can document the commitments 12 and document the relationship between commitments 14. Valid commitment sources 11 are typically sources such as an administrative rule, a BAFO, a contract, a business rule, a decision log, a policy, a proposal, a question and answer exchange, an RFP, or some identified stakeholder need. Note that in the preferred embodiment, the commitment source 11 would be available to the vendor or second party, and in this manner, the second party can evaluate both the commitments 12 and the commitment sources 11 during the negotiation phase of an agreement or when deciding how to populate its work breakdown section 15. This is a feature that lends transparency and imparts efficiency to the commitment tracking system 10.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to a particular embodiment disclosed as the best mode contemplated for carrying out this invention, but that the invention will include all embodiments falling within the scope of the appended claims.

What is claimed is:

1. A commitment tracking system for allowing interactive cooperation between a vendor and a contracted party regarding artifacts and commitments, the system comprising:
a commitment tracking system home page that includes;
a commitment sources symbol with an active link to a commitment sources list window wherein the commitment sources list window displays information regarding commitment sources;
a commitments symbol with an active link to a commitments list window wherein the commitments list window displays information regarding individual commitments;
a project symbol providing an active link to a project list window wherein the project list window displays information regarding projects;
a deliverables symbol providing an active link to a deliverables list window wherein the deliverables list window displays information regarding deliverables; and
an artifacts symbol providing an active link to an artifact list window wherein the artifact list window displays information regarding artifacts; and
wherein the artifacts can be documented so as to comprise each deliverable; and
wherein the artifacts can be assigned to a commitment.

2. The commitment tracking system according to claim 1, further comprising a user operable selector providing representation of all artifacts making up each deliverable.

3. The commitment tracking system according to claim 1, further comprising a user operable selector providing association of one or more artifacts with a commitment.

4. The commitment tracking system according to claim 1, further comprising a user operable selector to link a commitment to an artifact.

5. The commitment tracking system according to claim 1, further comprising a user operable selector enabling a user's acceptance or rejection of an artifact.

6. The commitment tracking system according to claim 1, further comprising an artifact detail window linked to the artifact list window.

7. The commitment tracking system according to claim 1, further comprising an artifact-commitment window linked to the artifact list window.

8. The commitment tracking system according to claim 1, further comprising an artifact acceptance window linked to the artifact list window.

9. The commitment tracking system according to claim 1, further comprising an artifact vendor submission window linked to the artifact list window.

10. The commitment tracking system according to claim 1, further comprising a commitment-artifacts window linked to the commitment list window.

11. The commitment tracking system according to claim 1, further comprising a commitment details window linked to the commitment list window.

12. A method for tracking the satisfaction of commitments between a first party and at least one second party, the method comprising the steps of:
providing a first location for the first party to introduce data to establish commitment sources and a list of commitments;
providing a second location for the second party to introduce data to establish a list of projects, a list of deliverables, and a list of artifacts; and
providing further locations for:
(i) the second party to link artifacts to deliverables;
(ii) the first party linking a commitment to one or more artifacts;
(iii) the first party to indicate acceptance or rejection criteria for artifacts;
(iv) the second party to assign artifacts to commitments; and
(v) the first party to accept or reject artifacts.

13. The method according to claim 12, further comprising the step of providing a location for the first party to elaborate acceptance criteria for an artifact.

14. The method according to claim 12, wherein the step of providing a further location for the first party to indicate acceptance or rejection of an artifact comprises providing an active artifact acceptance button representation positioned within an artifact acceptance window.

15. The method according to claim 12, further comprising the step of providing a site for adding additional artifacts beyond said list of artifacts, and providing a site for adding additional commitments beyond said list of commitments..

16. The method according to claim 15, further comprising the step of providing a site for updating commitment information within a commitment details window.

17. The method according to claim 15, further comprising the step of providing a site for updating artifact information within an artifact details window.

18. A method for tracking the satisfaction of commitments between at least a first party and a second party, the method comprising the steps of:
providing a commitment source list window where one or more agents of the first party may provide data to establish commitment sources by inputting data;
providing a commitments list window where one or more agents of the first party may provide data to establish a list of commitments by inputting data;
providing a project list window where one or more agents of the second party may provide data to establish a list of projects by inputting data;
providing a deliverable list window where one or more agents of the second party may provide data to establish a list of deliverables by inputting data;
providing an artifacts list window where one or more agents of the second party may provide data to establish a list of artifacts by inputting data;
providing an artifacts list window where one or more agents of the second party may assign an artifact to a deliverable;
providing a commitment-artifacts window where one or more agents of the first party may link commitments to artifacts;
providing an artifact details window where one or more agents of the first party may document acceptance criteria for artifacts;
providing an artifact-commitments window where one or more agents of the second party may assign artifacts to commitments; and
providing an artifact acceptance window where one or more agents of the first party may accept artifacts.

19. The method according to claim 18, wherein the step of providing an artifact acceptance window where one or more agents of the first party may accept artifacts further comprises providing a site for identifying a date of acceptance.

20. The method according to claim 18, wherein the step of providing an artifacts list window where one or more agents of the second party may provide data to establish a list of artifacts further comprises providing a site for an artifact identification, an artifact description, an artifact type, and a submission due date.

21. The method according to claim 18, wherein the step of providing a deliverable list window where one or more agents of the second party provide data to establish a list of deliverables further comprises providing a site for a deliverable identification, a deliverable description, a project, and a deliverable stakeholder.

22. The method according to claim 18, wherein the step of providing a commitment list window where one or more agents of the first party may provide data to establish a commitment list further comprises providing a site for a commitment identification, a commitment source, a commitment type, a source section, and a commitment description.

23. The method according to claim 18, wherein the step of providing a commitment source list window where one or more agents of the first party may provide data to establish a commitment source list further comprises providing a site for a commitment source, a commitment precedence, a lock option, and a lock date.

24. The method according to claim 18, further comprising the step of providing a site where the second party may agree to be bound to the commitment list provided by the first party, and providing a site where the first party may agree to be bound to the artifact list provided by the second party.

25. Computer programming including machine readable and executable code on a discrete medium or media including routines for effecting the methods according to any one of claims 12-25.
